(19) United States
(12) Patent Application Publication
(10) Pub. No.: US 2025/0217797 A1
(43) Pub. Date: Jul. 3, 2025

(54) SYSTEMS AND METHODS FOR GENERATING A METAVERSE ASSET BASED ON SECURING A PHYSICAL OBJECT

(71) Applicant: Wells Fargo Bank, N.A., San Francisco, CA (US)

(72) Inventors: Manpreet Singh, Hyderabad (IN); Michael Knorr, Fairfield, CT (US); Dan S. Sumner, Matthews, NC (US)

(21) Appl. No.: 18/402,030

(22) Filed: Jan. 2, 2024

(51) Int. Cl. G06Q 20/38; G06Q 20/06

(52) U.S. Cl. CPC G06Q 20/38215; G06Q 20/065

(57) ABSTRACT

Systems, apparatuses, methods, and computer program products are disclosed for generating a metaverse asset based on securing a physical object. An example method includes authenticating a user to a metaverse instance using metaverse credentials and authenticating the user to a transaction server using transaction server credentials. The example method further includes securing and scanning a physical object, generating scanned object raw data. The example method further includes generating a metaverse representation of the physical object based on the scanned object raw data, broadcasting the minting and ownership of a metaverse asset to the metaverse instance, where the metaverse asset comprises a link to the metaverse representation of the physical object, where the ownership is associated with the metaverse credentials and providing an indication of securing the physical object and an indication of broadcasting ownership of the metaverse asset to the transaction server.

### BACKGROUND

Safety deposit boxes are common tools for customers at almost any branch of a financial institution. A safety deposit box provides a physical locker that keeps important documents, valuables, and the like safe and secure from thieves, accidental damage, and other dangers. The safety deposit box is a physical element that requires customers to be present at the branch in person to access the locker, but metaverse and distributed ledger technology enable customers to perform certain transaction and experience certain products in a decentralized, virtual world.

### BRIEF SUMMARY

The safety deposit box is a long-standing essential service for many bank customers, enabling safe storage of documents, valuables, and the like. Meanwhile, metaverse, distributed ledgers, and web 3.0 technology are poised to revolutionize the way commerce and financial services are conducted. Metaverse technology has already begun to open up large markets of digital goods that are being actively traded.

To encourage customers to conduct business on the metaverse, various incentives may be offered. For example, vendors may offer metaverse benefits that mirror a real-life purchase, such as a clothing item for a metaverse avatar that mirrors a real-world clothing purchase. However, such metaverse items are typically specific to certain retail items that enable such functionality, and not generalizable to a wider variety of real-world goods.

Example embodiments described herein serve to create a platform for the generalized creation of metaverse items based on real-world property by using the principle of a bank safety deposit box. This approach avoids historical limitations of linking highly-specific metaverse goods to real-world items, and adds value for bank customers using safety deposit box services.

Accordingly, the present disclosure sets forth systems, methods, and apparatuses that enable customers to both store and protect valuables while gaining a benefit in a metaverse instance, distributed ledger, blockchain, or the like. There are many advantages of these and other embodiments described herein. For instance, customers are incentivized to use banking safety deposit box services, increasing a financial institution's interaction with customers and creating potential for additional services to be utilized. In addition, customers may be incentivized to perform further interactions in metaverse instances or other web 3.0 technologies. By giving users the new ability to utilize a representation of a valuable item in the metaverse, customers may have more incentive to further trade and interact using the metaverse or other platforms.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for generating a metaverse asset based on securing a physical object.

FIG. 2 illustrates a schematic block diagram of example circuitry embodying a system device that may perform various operations in accordance with some example embodiments described herein.

FIG. 3 illustrates an example flowchart for generating a metaverse asset based on securing a physical object, in accordance with some example embodiments described herein.

FIG. 4A illustrates an example flowchart for generating a financial offer based on a scanned object, in accordance with some example embodiments described herein.

FIG. 4B illustrates an example flowchart for minting a non-fungible token (NFT) based on a scanned object, in accordance with some example embodiments described herein.

FIG. 5 illustrates an example flowchart for generating a metaverse representation of a scanned object, in accordance with some example embodiments described herein.

FIG. 6 illustrates an example flowchart for maintaining presence of the scanned object in the electronically-locked secure volume, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

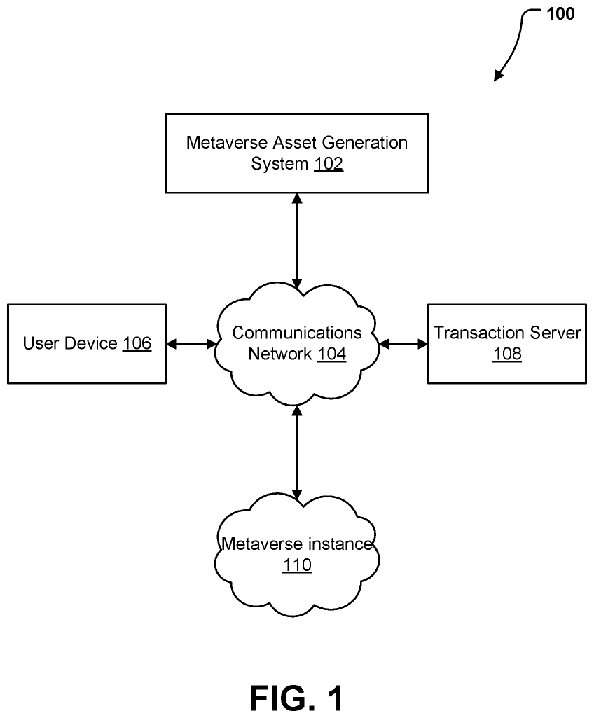

Example embodiments described herein may be implemented using any of a variety of computing devices or servers. To this end, FIG. 1 illustrates an example environment 100 within which various embodiments may operate. As illustrated, a metaverse asset generation system 102 may receive and/or transmit information via communications network 104 (e.g., the Internet) with any number of other devices, such as one or more of user device 106 and/or transaction server 108.

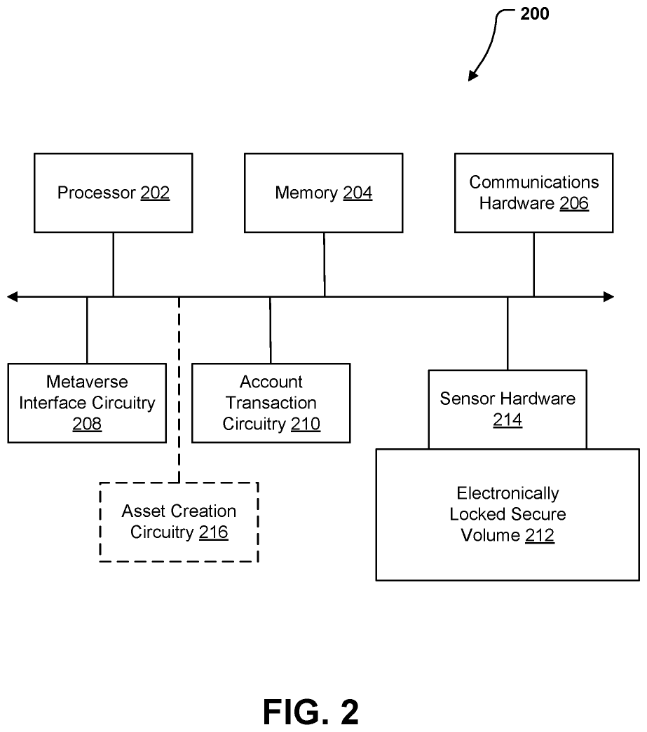

The metaverse asset generation system 102 may be implemented as one or more computing devices or servers, which may be composed of a series of components. Particular components of the metaverse asset generation system 102 are described in greater detail below with reference to apparatus 200 in connection with FIG. 2.

The user device 106 and the transaction server 108 may be embodied by any computing devices known in the art. The user device 106 and the transaction server 108 need not themselves be independent devices, but may be peripheral devices communicatively coupled to other computing devices. Although FIG. 1 depicts a single user device 106 and a single transaction server 108, it will be understood that multiple user devices and/or transaction servers may be in communication with the metaverse asset generation system 102 via communications network 104.

The transaction server 108 may be embodied by a physical server device, cloud server service, or any other service providing networked computing services of the transaction server 108. The transaction server 108 may be configured to store and authenticate login accounts for users, and may be a separate login and authentication system from a metaverse instance 110, maintaining separate records. In some embodiments, the transaction server 108 may be configured to store and manage a bank account, a financial services account, an investment account, and/or the like. In some embodiments, the transaction server 108 may be configured to store and maintain records of a physical object stored in an electronically-locked secure volume and store details about the physical object, details about monetary value of the financial object, the user associated with the stored physical object, and/or the like.

The communications network 104 may be in communication with a metaverse instance 110. The metaverse instance 110 may be embodied as a server or collection of servers that provide a virtual world for users to interact with, including activities such as buying and selling services, and may interface with decentralized applications such as a distributed ledger to track or enable certain functionality. User identities may be embodied as one or more user avatars, which may be virtual identities served by the one or more physical devices embodying the metaverse instance 110, or may be embodied in separate devices. User avatars may have certain user-defined features such as appearance, language settings, and the like, that mediate the interaction of users on the metaverse instance 110.

As mentioned, the metaverse instance 110 further comprises a collection of networked distributed ledger nodes of a blockchain, which may be permissionless (public) or permissioned (private). The distributed ledger may use any distributed ledger or blockchain technology that is capable of creating and exchanging blockchain tokens or NFTs. In some embodiments, the distributed ledger may allow for Turing-complete scripting of contracts, known also as smart contracts, distributed applications, or decentralized applications, to be executed on the distributed ledger or blockchain. The distributed ledger may be related to other blockchain networks not pictured here. For example, the distributed ledger may be a sidechain of another blockchain network, or another network (not shown) may form a sidechain of the distributed ledger. The nodes may be embodied by specialized node devices, or may be embodied by any computing devices or server devices known in the art. In some embodiments the metaverse asset generation system 102 itself may be a node of the distributed ledger, or the metaverse asset generation system 102 may be external to the blockchain and/or metaverse instance 110.

Although FIG. 1 illustrates an environment and implementation in which the metaverse asset generation system 102 interacts indirectly with a user via user device 106, in some embodiments users may directly interact with the metaverse asset generation system 102 (e.g., via communications hardware of the metaverse asset generation system 102), in which case a separate user device 106 may not be utilized. Whether by way of direct interaction or indirect interaction via another device, a user may communicate with, operate, control, modify, or otherwise interact with the metaverse asset generation system 102 to perform the various functions and achieve the various benefits described herein (e.g., installation, initialization, repair, debugging of the metaverse asset generation system 102).

### Example Implementing Apparatuses

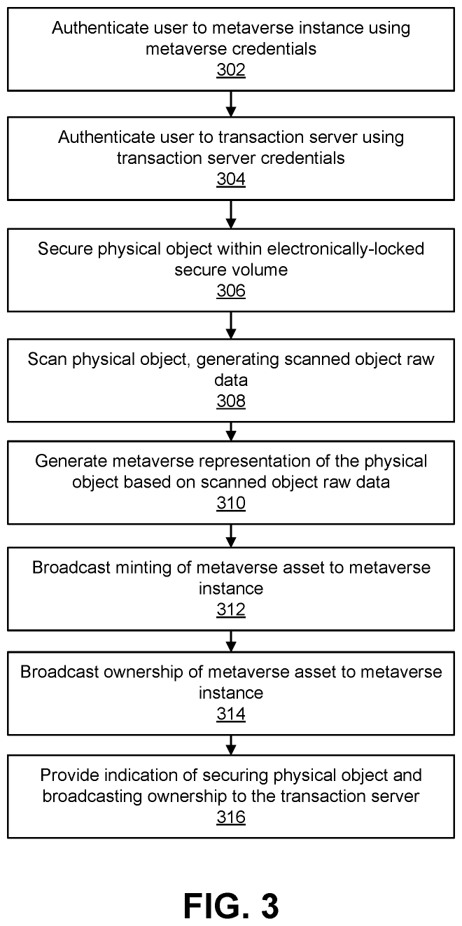

The metaverse asset generation system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-6. As illustrated in FIG. 2, the apparatus 200 may include processor 202, memory 204, communications hardware 206, metaverse interface circuitry 208, account transaction circuitry 210, electronically locked secure volume 212, sensor hardware 214, and asset creation circuitry 216, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a metaverse interface circuitry 208 that authenticates a user to a metaverse instance 110, generates a metaverse representation of a physical object, and broadcasts minting and/or ownership of a metaverse asset to a metaverse instance 110. The metaverse interface circuitry 208 may utilize processor 202, memory 204, or any other hardware component included in the apparatus 200 to perform these operations, as described in connection with FIGS. 3-6 below. The metaverse interface circuitry 208 may further utilize communications hardware 206 to gather data from a variety of sources (e.g., transaction server 108 and/or metaverse instance 110 as shown in FIG. 1), and/or exchange data with a user, and in some embodiments may utilize processor 202 and/or memory 204 to interface to a metaverse instance 110.

In addition, the apparatus 200 further comprises an account transaction circuitry 210 that authenticates a user and provides an indication of securing a physical object and ownership of the metaverse asset to a transaction server 108. The account transaction circuitry 210 may utilize processor 202, memory 204, or any other hardware component included in the apparatus 200 to perform these operations, as described in connection with FIGS. 3-6 below. The account transaction circuitry 210 may further utilize communications hardware 206 to gather data from a variety of sources (e.g., user device 106 or transaction server 108, as shown in FIG. 1), and/or exchange data with a user, and in some embodiments may utilize processor 202 and/or memory 204 to interface to a transaction server 108.

Further, the apparatus 200 further comprises an electronically locked secure volume 212 that secures a physical object. The electronically locked secure volume 212 comprises an enclosure resistant to physical tampering and intrusions. An electronic locking mechanism is positioned in or near the secure volume and activated or deactivated through attached circuitry of the apparatus 200. The electronic locking mechanism of the electronically locked secure volume 212 may be additionally activated by an attached user interface comprising, for example, a keypad, biometric scanner, or other means of operating the lock.

In addition, the apparatus 200 further comprises a sensor hardware 214 that scans a physical object, generating scanned object raw data and identifies the physical object within the electronically locked secure volume. The sensor hardware 214 may utilize processor 202, memory 204, or any other hardware component included in the apparatus 200 to perform these operations, as described in connection with FIGS. 3-6 below. The sensor hardware 214 may further utilize communications hardware 206 to gather data from a variety of sources (e.g., user device 106 or transaction server 108, as shown in FIG. 1), and/or exchange data with a user, and in some embodiments may utilize processor 202 and/or memory 204 to scan physical objects in the electronically locked secure volume 121. The sensor hardware 214 may include any sensor devices known in the art, including cameras, scales, laser scanners, radiofrequency identification (RFID), light detection and ranging (LiDAR) and the like. The sensor hardware 214 may include sensors for imaging, detection of electronic signatures, measurement of weight or other physical properties, and the like. The sensor hardware 214 may further include circuitry for processing the raw data from attached sensor hardware for providing processed and interpreted data to the attached hardware of apparatus 200, for example, formatted images, calibrated numerical values, and the like.

In some embodiments, the sensor hardware 214 comprises an automatic identification and data capture (AIDC) sensor device. The AIDC sensor device may include, for example, capabilities to read QR codes, bar codes, RFID, biometrics, magnetic strips, optical character recognition (OCR), smart cards, and/or the like. In an instance in which the physical object scanned in the electronically locked secure volume 212 comprises a recognizable AIDC identifier, the sensor hardware 214 may capture the identification information through attached AIDC sensors. In some embodiments, the sensor hardware 214 comprises cash scanning hardware. The sensor hardware 214 may include, for example, specialized scanners to detect legitimate cash notes, mechanical parts for feeding cash into the electronically locked secure volume 212, and the like.

In addition, the apparatus 200 may further comprise an asset creation circuitry 216 that generates a random seed value, processes scanned object raw data to generate cleaned scanned object data, and executes a generative asset creation model to create a metaverse asset. The asset creation circuitry 216 may utilize processor 202, memory 204, or any other hardware component included in the apparatus 200 to perform these operations, as described in connection with FIGS. 3-6 below. The asset creation circuitry 216 may further utilize communications hardware 206 to gather data from a variety of sources (e.g., user device 106 or transaction server 108, as shown in FIG. 1), and/or exchange data with a user, and in some embodiments may utilize processor 202 and/or memory 204 to generate metaverse assets.

Although components 202-216 are described in part using functional language, it will be understood that the particular implementations necessarily include the use of particular hardware. It should also be understood that certain of these components 202-216 may include similar or common hardware. For example, the metaverse interface circuitry 208, account transaction circuitry 210, electronically locked secure volume 212, sensor hardware 214, and asset creation circuitry 216 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” with respect to elements of the apparatus therefore shall be interpreted as necessarily including the particular hardware configured to perform the functions associated with the particular element being described. Of course, while the terms “circuitry” should be understood broadly to include hardware, in some embodiments, the terms “circuitry” may in addition refer to software instructions that configure the hardware components of the apparatus 200 to perform the various functions described herein.

Although the metaverse interface circuitry 208, account transaction circuitry 210, sensor hardware 214, and asset creation circuitry 216 may leverage processor 202, memory 204, or communications hardware 206 as described above, it will be understood that any of metaverse interface circuitry 208, account transaction circuitry 210, sensor hardware 214, and asset creation circuitry 216 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that metaverse interface circuitry 208, account transaction circuitry 210, sensor hardware 214, and asset creation circuitry 216 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of flowcharts.

### Example Operations

Turning to FIGS. 3-6, example flowcharts are illustrated that contain example operations implemented by example embodiments described herein. The operations illustrated in FIGS. 3-6 may, for example, be performed by the metaverse asset generation system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, metaverse interface circuitry 208, account transaction circuitry 210, electronically locked secure volume 212 sensor hardware 214, and/or asset creation circuitry 216. It will be understood that user interaction with the metaverse asset generation system 102 may occur directly via communications hardware 206, or may instead be facilitated by a separate user device 106, as shown in FIG. 1, and which may have similar or equivalent physical componentry facilitating such user interaction.

Turning first to FIG. 3, example operations are shown for generating a metaverse asset based on securing a physical object. As shown by operation 302, the apparatus 200 includes means, such as processor 202, memory 204, communications hardware 206, metaverse interface circuitry 208, or the like, for authenticating a user to a metaverse instance 110 using metaverse credentials. The metaverse interface circuitry 208 may use communications hardware 206 to establish a secure communication channel with a login server or other authentication device of a metaverse instance 110. The metaverse interface circuitry 208 may exchange cryptographic keys or perform other actions to establish the secure communication channel. The metaverse interface circuitry 208 may transmit login information to authenticate the user to the metaverse instance 110, such as a username and password, or may provide other factors to complete authentication (e.g., one-time password, biometrics, or the like).

The metaverse interface circuitry 208 may authenticate the user to access an account that is particular to the metaverse instance 110, or in some embodiments the account may be shared among additional servers and/or services. The user may access a metaverse account on the metaverse instance 110 that includes an avatar and various digital assets owned by the user on the metaverse instance 110. In some embodiments, the assets owned by the user on the metaverse instance 110 may be owned based on a record on a distributed ledger associated with the metaverse instance 110.

As shown by operation 304, the apparatus 200 includes means, such as processor 202, memory 204, communications hardware 206, account transaction circuitry 210, or the like, for authenticating a user to a transaction server 108 using transaction server credentials. The account transaction circuitry 210 may use communications hardware 206 to establish a secure communication channel with a login server or other authentication device of a transaction server 108. The account transaction circuitry 210 may exchange cryptographic keys or perform other actions to establish the secure communication channel. The account transaction circuitry 210 may transmit login information to authenticate the user to the transaction server 108, such as a username and password, or may provide other factors to complete authentication (e.g., one-time password, biometrics, or the like).

The account transaction circuitry 210 may authenticate the user to access an account associated with, operated by, and/or stored on the transaction server 108. The account may be associated with financial transactions, investments, loans, payment cards, banking, and/or other financial services of the user. The account may maintain an indication of value of certain property owned by the user for establishing credit ratings, collateral, or the like.

As shown by operation 306, the apparatus 200 includes means, such as processor 202, memory 204, electronically locked secure volume 212, or the like, for securing a physical object. The physical object may be secured within an electronically locked secure volume 212. In some embodiments, the electronically locked secure volume 212 may receive a physical object placed within the volume by a user. The electronic lock of the electronically locked secure volume 212 may activate by any of the attached hardware of the electronically locked secure volume 212 (e.g., keypad, biometric sensor, timer used to activate a locking mechanism). The electronically locked secure volume 212 may use any locking mechanism known in the art to secure the physical object, preventing removal of the physical object and protecting the physical object from tampering, theft, or other intrusion. The electronically locked secure volume 212 may provide an indication that the physical object is stored within, and the indication may be transmitted to other attached circuitry of the apparatus 200.

The physical object may be any object of value placed in the electronically locked secure volume 212 by the user. In some embodiments, the physical object may be a cash note. In some embodiments, the physical object may be jewelry, artwork, clothing, or the like. In some embodiments, the physical object may include an AIDC identifier that may be detectable by sensor hardware 214.

As shown by operation 308, the apparatus 200 includes means, such as processor 202, memory 204, communications hardware 206, sensor hardware 214, or the like, for scanning the physical object, wherein scanning generates scanned object raw data. The sensor hardware 214, as described above, may include various attached hardware for collecting data characterizing the physical object (e.g., imaging, physical properties, electronic signals, and the like). The sensor hardware 214 may activate various sensor devices as appropriate for the physical object stored in the electronically locked secure volume 212. As described above, in some embodiments the sensor hardware 214 may include circuitry for processing data from various sensors to prepare and package data to be provided to other attached circuitry of the apparatus 200. Whether the sensor hardware 214 directly streams sensor data to the apparatus 200 or intermediate circuitry of the sensor hardware 214 performs a processing step, the data provided by the sensors hardware 214 may be referred to as scanned object raw data. The scanned object raw data may comprise a raw byte stream from hardware sensors, or in some embodiments the scanned object raw data may have a preliminary level of processing, so that the scanned object raw data may include formatted text, images, or the like.

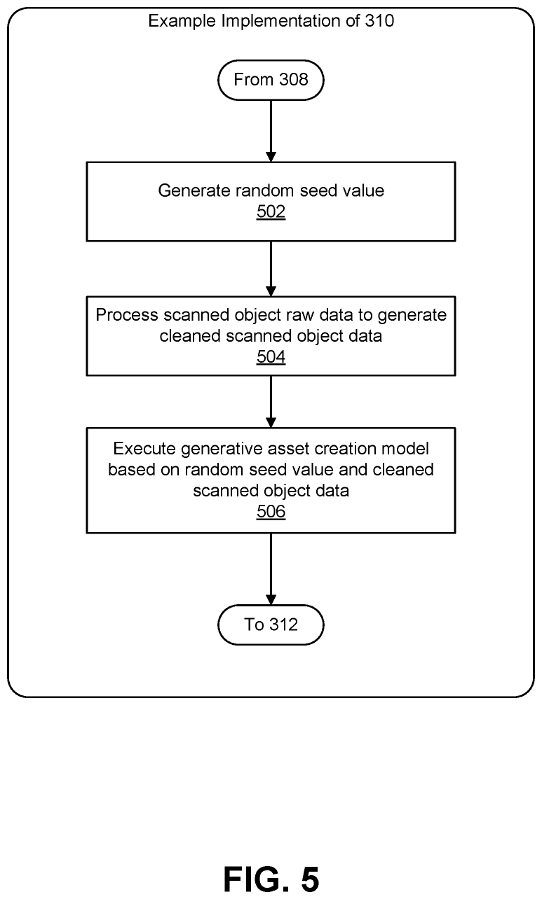

As shown by operation 310, the apparatus 200 includes means, such as processor 202, memory 204, communications hardware 206, metaverse interface circuitry 208, asset creation circuitry 216, or the like, for generating, based on the scanned object raw data, a metaverse representation of the physical object. A detailed description of generating the metaverse representation of the physical object is given below in connection with FIG. 5. The metaverse representation of the physical object may be a unique and identifiable digital object that exists in the context of the metaverse instance 110. Metaverse assets may be any of a wide variety of digital objects ranging from virtual avatars, wearable accessories, digital artwork, land or other property in the metaverse, or the like. In some embodiments, metaverse assets may be recorded and stored on a distributed ledger associated with the metaverse instance 110. The metaverse instance may be represented as any of a variety of data structures known in the art, including digital images, 3D models, text files, or the like, and may include metadata including ownership history, properties, attributes, permissions, and the like.

In some embodiments, the metaverse asset comprises an NFT. The NFT may be a unique and identifiable object that may be used to represent ownership of the metaverse representation of the physical object and/or the physical object itself. The NFT may be created and managed using a smart contract and stored on a blockchain associated with the metaverse instance 110.

As shown by operation 312, the apparatus 200 includes means, such as processor 202, memory 204, communications hardware 206, metaverse interface circuitry 208, or the like, for broadcasting minting of a metaverse asset to the metaverse instance 110, wherein the metaverse asset comprises a link to the metaverse representation of the physical object. The metaverse interface circuitry 208 may broadcast the minting of the metaverse asset via the communications hardware 206. In some embodiments, the metaverse asset may be recorded using a distributed ledger or blockchain, and the metaverse interface circuitry 208 may broadcast the minting of the metaverse asset over the distributed ledger. The transmission causing the creation of the metaverse asset may be digitally signed and the minting may be entered into a block on the digital ledger. Subsequent changes, such as a transfer of ownership of the metaverse asset, may be broadcast to and recorded by the distributed ledger in subsequent blocks. The metaverse instance 110 and associated distributed ledger may perform verification of the digitally signed transmission causing the creation of the metaverse asset. The transmission may also use the established authenticated session described in connection with operation 302.

As shown by operation 314, the apparatus 200 includes means, such as processor 202, memory 204, communications hardware 206, metaverse interface circuitry 208, or the like, for broadcasting ownership of the metaverse asset to the metaverse instance 110, wherein the ownership is associated with the metaverse credentials. As described above in connection with operation 312, the metaverse interface circuitry 208 may similarly broadcast the ownership of the metaverse asset via the communications hardware 206 to the metaverse instance 110 and associated distributed ledger of the metaverse instance 110. The transfer of ownership of the metaverse asset may be broadcast to and recorded by the distributed ledger in one or more distributed ledger blocks. The metaverse instance 110 and associated distributed ledger may perform verification of the digitally signed transmission recording ownership of the metaverse asset. The transmission may also use the established authenticated session described in connection with operation 302.

As shown by operation 316, the apparatus 200 includes means, such as processor 202, memory 204, communications hardware 206, account transaction circuitry 210, or the like, for providing, to the transaction server 108, an indication of securing the physical object and an indication of broadcasting ownership of the metaverse asset. The account transaction circuitry 210 may provide, via the communications hardware 206, the transmission to the transaction server 108. The transmission may include an indication of securing the physical object and an indication of broadcasting ownership of the metaverse asset, and the transmission may further include indication of broadcasting the minting of the metaverse asset. The transmission may use the authenticated session described previously in connection with operation 304, including encryption established as part of a secure session for communication with the transaction server 108.

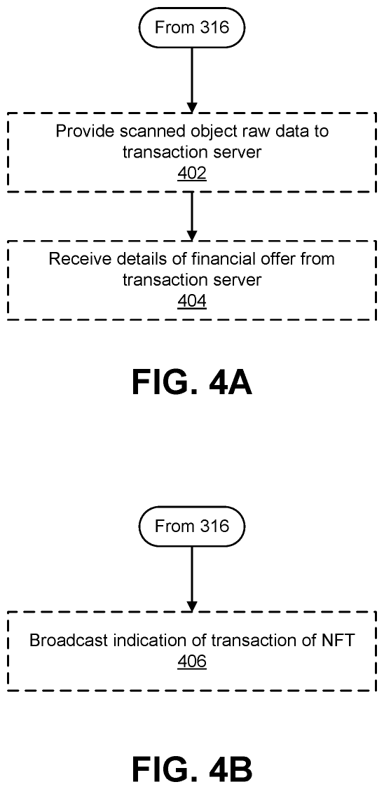

Turning now to FIG. 4A, example operations are shown for generating a financial offer based on a scanned object. As shown by operation 402, the apparatus 200 may include means, such as processor 202, memory 204, communications hardware 206, account transaction circuitry 210, or the like, for providing the scanned object raw data to the transaction server 108. As described previously, the scanned object raw data may be obtained when the sensor hardware 214 collects data regarding the physical object secured within the electronically locked secure volume 212. The account transaction circuitry 210 may cause the communication hardware 206 to transmit the scanned object raw data to the transaction server 108. The transmission may use, for example, an authenticated session described previously in connection with operation 304, including encryption established as part of a secure session for communication with the transaction server 108.

As shown by operation 404, the apparatus 200 may include means, such as processor 202, memory 204, communications hardware 206, account transaction circuitry 210, or the like, for receiving, from the transaction server 108, details of a financial offer, wherein the financial offer is based on a monetary value of the physical object. The account transaction circuitry 210 may receive the financial offer via the communications hardware 206. The financial offer may be made based on the monetary value of the physical object, which in turn may be determined based on the scanned object raw data described previously in connection with operation 402. For example, the monetary value of the physical object may be used to provide collateral, and the financial offer may be a loan offer based on the collateral of the physical object. In some embodiments, the monetary value of the physical object may be used to modify a credit rating of a user. In some embodiments, the financial offer may be contingent upon the physical object remaining within the electronically locked secure volume 212.

Turning now to FIG. 4B, example operations are shown for minting an NFT based on a scanned object. As shown by operation 406, the apparatus 200 may include means, such as processor 202, memory 204, communications hardware 206, metaverse interface circuitry 208, or the like, for broadcasting, to the metaverse instance, an indication of a transaction of the NFT. The metaverse interface circuitry 208 may broadcast the indication of the transaction using the communications hardware 206 to the metaverse instance 110. As described previously, the broadcast regarding the NFT may cause a distributed ledger of the metaverse instance 110 to create a block on the distributed ledger recording the transaction. The broadcast of the indication of the transaction may be digitally signed and may include information such as the original owner, subsequent owner, metadata regarding the transaction, and other information.

In some embodiments, operation 310 may be performed in accordance with the operations described by FIG. 5. Turning now to FIG. 5, example operations are shown for generating a metaverse representation of the physical object based on scanned object raw data. As shown by operation 502, the apparatus 200 includes means, such as processor 202, memory 204, asset creation circuitry 216, or the like, for generating a random seed value. The asset creation circuitry 216 may generate a pseudo-random value, for example by taking and transforming the current time or any other suitable similar source of pseudorandom values. In some embodiments, a true random number may be obtained from a suitable entropy source and used as a seed value.

As shown by operation 504, the apparatus 200 includes means, such as processor 202, memory 204, asset creation circuitry 216, or the like, for processing the scanned object raw data to generated cleaned scanned object data. The asset creation circuitry 216 may clean, infill, interpolate, or otherwise cleanse the scanned object raw data to provide data suitable for providing to a generative asset creation model. For example, imaging data may be cleansed by removing images that include moments when the user may have placed the physical object within the electronically locked secure volume 212, causing the image to include the user's hands in the data. Scanned object raw data may also be normalized, parsed, have duplicates removed, and/or have other simple statistical or other operations performed.

Finally, as shown by operation 506, the apparatus 200 includes means, such as processor 202, memory 204, communications hardware 206, metaverse interface circuitry 208, account transaction circuitry 210, electronically locked secure volume 212, sensor hardware 214, asset creation circuitry 216, or the like, for executing a generative asset creation model based on the random seed value and the cleaned scanned object data, wherein executing the generative asset creation model creates the metaverse asset, wherein the metaverse asset is procedurally generated. The term “procedurally generated” may refer to generating a unique metaverse asset based on the physical object, which is contrasted with retrieving a pre-determined metaverse asset based on a dictionary or pre-determined catalog of metaverse assets. For example, the procedural generation may be a rules-based method that uses properties of the physical object such as shape, color, weight, material, and/or the like, in addition to the random seed. The procedural generation may also use generative artificial intelligence.

The generative asset creation model may be any generative model, such as a generative adversarial network or other models based on deep learning neural networks, such as transformers, auto-encoders, or the like. The generative asset creation model may be trained on training datasets to produce metaverse assets resembling real-world physical objects based on a received cleaned scanned object data prompt. The generative asset creation model may also, in some embodiments, use a random value to generate the metaverse asset in conjunction with the cleaned scanned object data prompt, where the random value may add a randomness factor to the generated metaverse asset, promoting uniqueness of generated assets.

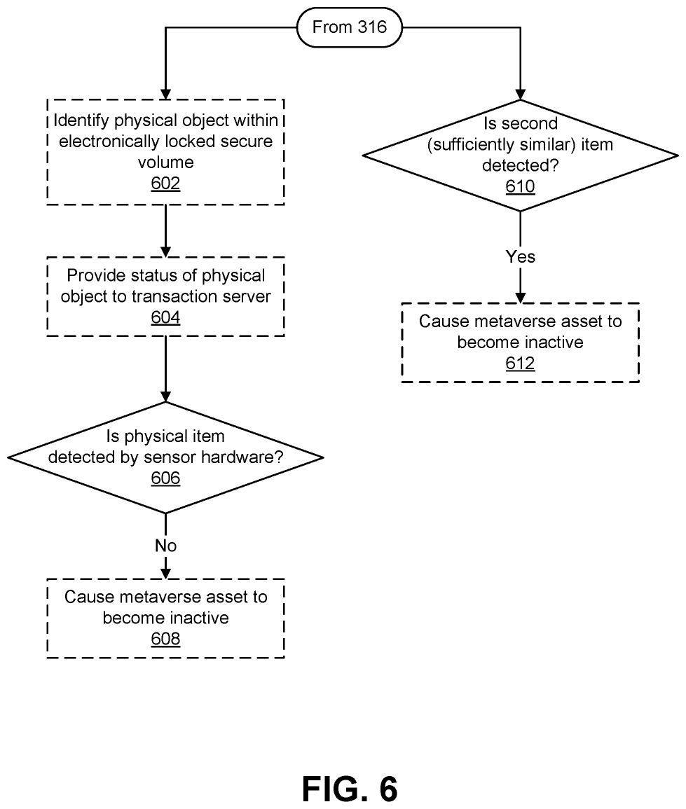

Turning next to FIG. 6, example operations are shown for maintaining presence of the scanned object in the electronically-locked secure volume. As shown by operation 602, the apparatus 200 may include means, such as processor 202, memory 204, electronically locked secure volume 212, sensor hardware 214, or the like, for identifying the physical object within the electronically locked secure volume 212. The sensor hardware 214 may identify the physical object using the same procedure as described above in connection with operation 308 for performing the initial scan of the physical object. In some embodiments, the sensor hardware 214 may subsequently identify the physical object at a later time after initially scanning the physical object.

As shown by operation 604, the apparatus 200 may include means, such as processor 202, memory 204, communications hardware 206, account transaction circuitry 210, sensor hardware 214, asset creation circuitry 216, or the like, for providing a status of the physical object to the transaction server 108. The account transaction circuitry 210 may provide, via the communications hardware 206, the status to the transaction server 108. The status of the physical object may include an indication of securing the physical object and any other scanned object raw data collected in connection with operation 602. In some embodiments, the sensor hardware 214 and/or account transaction circuitry 210 may determine any changes in the scanned object raw data compared to earlier information concerning the physical object and transmit the changes to the transaction server 108. The transmission may use the authenticated session described previously in connection with operation 304, including encryption established as part of a secure session for communication with the transaction server 108.

As shown by decision block 606, control may depend on a determination of whether the physical item is detected by sensor hardware. In an instance in which the physical object is not detected by the sensor hardware 214, control may pass to operation 608. In an instance in which the physical object is detected by the sensor hardware 214, the apparatus 200 may continue to repeat operations 602 and 604 at pre-determined intervals, monitoring for the presence of the physical object.

As shown by operation 608, the apparatus 200 may include means, such as processor 202, memory 204, communications hardware 206, metaverse interface circuitry 208, or the like, for in an instance in which the physical object is not detected by the sensor hardware, causing the metaverse asset to become inactive based on the smart contract. Deactivation of the metaverse asset may change the virtual characteristics of the metaverse asset. For instance, deactivation may cause the metaverse asset to render in grayscale rather than in color, or in a heavily pixelated form, or with a prominent watermark. In some embodiments, an inactive metaverse asset cannot be rendered in the metaverse environment (and deactivation may cause the metaverse asset to disappear from the metaverse environment, either in a gradual fashion over a period of time or in some cases instantaneously). In some embodiments, the metaverse asset may further comprise a smart contract. The smart contract may be an application or distributed application executed using notes of a distributed ledger which may be associated with the metaverse instance 110. The smart contract may take effect based on certain actions performed in the metaverse instance 110, and/or may take effect based on transmissions from a transaction server 108 that relate to ownership of the metaverse asset. For example, the smart contract may cause the metaverse asset to change ownership, change appearance, activate or deactivate, or perform any other arbitrary code instructions that the distributed ledger is capable of encoding on the smart contract.

In some embodiments, the metaverse interface circuitry 208 may cause the metaverse asset to become inactive based on the smart contract of the metaverse asset upon confirmation that the physical object is not detected within the electronically locked secure volume 212. In effect, removing the physical object from the electronically locked secure volume 212 may cause the metaverse asset relating to the physical object to become deactivated, using the associated smart contract. In some embodiments, the smart contract may be configured so that restoring the same physical object to the electronically locked secure volume 212 may re-activate the metaverse asset.

As shown by decision block 610, control may depend on a determination of whether a second physical object sufficiently similar to the physical object is detected. In an instance in which a second physical item is detected, control may pass to operation 612. In some embodiments, the physical item is related to a second scanned object raw data, and a measure of similarity of the scanned object raw data and the second scanned object raw data is determined to be within a pre-determined threshold. For example, to prevent a case where the same physical object is fraudulently used to generate multiple metaverse assets, a pre-determined threshold may be set for deciding that the physical object and the second physical object are the same object. The pre-determined threshold may be tuned to prevent false positive detections of duplicate objects and also to be robust enough against fluctuations in measurement of scanned object raw data. In an instance in which a second physical item is not detected, the apparatus 200 may continue to repeat decision block 610 at pre-determined intervals, monitoring for the presence of the physical object.

As shown by operation 612, the apparatus 200 may include means, such as processor 202, memory 204, communications hardware 206, metaverse interface circuitry 208, or the like, for in an instance in which a second physical item is detected, causing the metaverse asset to become inactive based on the smart contract. In some embodiments, the second physical item is related to second scanned object raw data, wherein a measure of similarity of the scanned object raw data and the second scanned object raw data is determined to be within a pre-determined threshold.

In some embodiments, the metaverse interface circuitry 208 may cause the metaverse asset to become inactive based on the smart contract of the metaverse asset upon confirmation that a second physical object is detected and determined to be sufficiently similar to the physical object. In effect, using the same physical object to attempt to generate a second metaverse asset may cause the metaverse asset relating to the physical object to become deactivated, using the associated smart contract.

FIGS. 3-6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations described above in connection with FIGS. 3-6 may be modified or further amplified. Furthermore, in some embodiments, additional optional operations may be included. Modifications, amplifications, or additions to the operations above may be performed in any order and in any combination.

### CONCLUSION

As described above, example embodiments provide methods and apparatuses that enable improved customer benefits from using safety deposit boxes. Example embodiments thus provide tools that overcome the problems faced by financial institutions incentivizing customers to use services, or entities operating on a metaverse instance seeking to incentivize customers. Moreover, embodiments described herein avoid limiting usage to pre-determined incentives that are linked to specific products.

As these examples all illustrate, example embodiments contemplated herein provide technical solutions that solve real-world problems faced during securing valuables in safety deposit boxes. And while electronic safety deposit boxes have existed for decades, the recent rise of the metaverse and distributed ledgers has unlocked new avenues in financial services that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for generating a metaverse asset based on securing a physical object, the method comprising:
authenticating, by metaverse interface circuitry, a user to a metaverse instance using metaverse credentials;
authenticating, by account transaction circuitry, the user to a transaction server using transaction server credentials;
securing, within an electronically locked secure volume, a physical object;
scanning, by sensor hardware, the physical object, wherein scanning the physical object generates scanned object raw data;
generating, by the metaverse interface circuitry and based on the scanned object raw data, a metaverse representation of the physical object;
broadcasting, by the metaverse interface circuitry, minting of a metaverse asset to the metaverse instance, wherein the metaverse asset comprises a link to the metaverse representation of the physical object;
broadcasting, by the metaverse interface circuitry, ownership of the metaverse asset to the metaverse instance, wherein the ownership is associated with the metaverse credentials; and
providing, by the account transaction circuitry and to the transaction server, an indication of securing the physical object and an indication of broadcasting ownership of the metaverse asset.

2. The method of claim 1, wherein the sensor hardware comprises an automatic identification and data capture (AIDC) sensor device, wherein scanning the physical object comprises detecting, by the AIDC sensor device, an AIDC identifier from the physical object.

3. The method of claim 1, further comprising:
providing, by the account transaction circuitry, the scanned object raw data to the transaction server; and
receiving, by the account transaction circuitry and from the transaction server, details of a financial offer, wherein the financial offer is based on a monetary value of the physical object.

4. The method of claim 1, wherein the metaverse asset comprises a non-fungible token (NFT).

5. The method of claim 4, further comprising:
broadcasting, by the metaverse interface circuitry and to the metaverse instance, an indication of a transaction of the NFT.

6. The method of claim 1, wherein the physical object is a cash note, wherein the sensor hardware comprises cash scanning hardware.

7. The method of claim 1, wherein generating the metaverse representation of the physical object comprises:
generating, by asset creation circuitry, a random seed value;
processing, by the asset creation circuitry, the scanned object raw data to generate cleaned scanned object data; and
executing, by the asset creation circuitry, a generative asset creation model based on the random seed value and the cleaned scanned object data, wherein executing the generative asset creation model creates the metaverse asset, wherein the metaverse asset is procedurally generated.

8. The method of claim 1, further comprising
identifying, by the sensor hardware, the physical object within the electronically locked secure volume; and
providing, by the account transaction circuitry, a status of the physical object to the transaction server.

9. The method of claim 1, wherein the metaverse asset further comprises a smart contract.

10. The method of claim 9, further comprising:
in an instance in which the physical object is not detected by the sensor hardware, causing, by the metaverse interface circuitry, the metaverse asset to become inactive based on the smart contract.

11. The method of claim 9, wherein a second physical item is related to a second scanned object raw data, wherein a measure of similarity of the scanned object raw data and the second scanned object raw data is determined to be within a pre-determined threshold, the method further comprising:
in an instance in which a second physical item is detected, causing the metaverse asset to become inactive based on the smart contract.

12. An apparatus for generating a metaverse asset based on securing a physical object, the apparatus comprising:
metaverse interface circuitry configured to authenticate a user to a metaverse instance using metaverse credentials;
account transaction circuitry configured to authenticate the user to a transaction server using transaction server credentials;
an electronically locked secure volume used to secure a physical object; and
sensor hardware configured to scan the physical object, wherein scanning the physical object generates scanned object raw data,
wherein the metaverse interface circuitry is further configured to:
generate, based on the scanned object raw data, a metaverse representation of the physical object,
broadcast minting of a metaverse asset to the metaverse instance, wherein the metaverse asset comprises a link to the metaverse representation of the physical object, and
broadcast ownership of the metaverse asset to the metaverse instance, wherein the ownership is associated with the metaverse credentials,
wherein the account transaction circuitry is further configured to provide, to the transaction server, an indication of securing the physical object and an indication of broadcasting ownership of the metaverse asset.

13. The apparatus of claim 12, wherein the sensor hardware comprises an AIDC sensor device, wherein the sensor hardware is configured to scan the physical object by detecting an AIDC identifier from the physical object.

14. The apparatus of claim 12, wherein the account transaction circuitry is further configured to:
provide the scanned object raw data to the transaction server; and
receive, from the transaction server, details of a financial offer, wherein the financial offer is based on a monetary value of the physical object.

15. The apparatus of claim 12, wherein the metaverse asset comprises an NFT.

16. The apparatus of claim 15, wherein the metaverse interface circuitry is further configured to broadcast, to the metaverse instance, an indication of a transaction of the NFT.

17. The apparatus of claim 12, wherein the physical object is a cash note, wherein the sensor hardware comprises cash scanning hardware.

18. The apparatus of claim 12, further comprising asset creation circuitry configured, wherein the metaverse interface circuitry is configured to generate the metaverse representation of the physical object by causing the asset creation circuitry to:
generate a random seed value;
process the scanned object raw data to generate cleaned scanned object data; and
execute a generative asset creation model based on the random seed value and the cleaned scanned object data, wherein executing the generative asset creation model creates the metaverse asset, wherein the metaverse asset is procedurally generated.

19. The apparatus of claim 12, wherein the sensor hardware is further configured to identify the physical object within the electronically locked secure volume,
wherein the account transaction circuitry is further configured to provide a status of the physical object to the transaction server.

20. A computer program product for generating a metaverse asset based on securing a physical object, the computer program product comprising at least one non-transitory computer-readable storage medium storing software instructions that, when executed, cause an apparatus to:
authenticate a user to a metaverse instance using metaverse credentials;
authenticate the user to a transaction server using transaction server credentials;
scan a physical object located within an electronically locked secure volume, wherein scanning the physical object generates scanned object raw data;
generate, based on the scanned object raw data, a metaverse representation of the physical object;
broadcast minting of a metaverse asset to the metaverse instance, wherein the metaverse asset comprises a link to the metaverse representation of the physical object;
broadcast ownership of the metaverse asset to the metaverse instance, wherein the ownership is associated with the metaverse credentials; and
provide, to the transaction server, an indication of securing the physical object and an indication of broadcasting ownership of the metaverse asset.
